(19) United States
(12) Patent Application Publication
(10) Pub. No.: US 2011/0219030 A1
(43) Pub. Date: Sep. 8, 2011

(54) DOCUMENT PRESENTATION USING RETRIEVAL PATH DATA

(76) Inventors: Daniel-Alexander Billsus, San Francisco, CA (US); Wei Chai, Union City, CA (US); Sam P. Hamilton, Los Altos, CA (US); Jonathan Blake Handler, Redwood City, CA (US); Nir Yeffet, Cupertino, CA (US)

(21) Appl. No.: 12/717,091

(22) Filed: Mar. 3, 2010

(51) Int. Cl. G06F 17/30; G06F 15/16; G06F 17/00; G06Q 30/00

(52) U.S. Cl. 707/770; 707/E17.108; 707/E17.008; 705/27.1

(57) ABSTRACT

The browsing activity of a first user is motivated by some intent. The first user requests retrieval of a particular document while browsing. A document processing and presentation machine associates the document with a retrieval path taken by the first user. By using the retrieval path data of the document, the document processing and presentation machine infers an intent that likely motivated the first user. When a second user makes a request similar to a request within the retrieval path, the machine presents the second user with the document and some of the retrieval path data, thus providing the second user with a shortcut that leads the second user directly to the document. Thus, the second user may be able to satisfy his intent with significantly less browsing activity compared to the first user.

### TECHNICAL FIELD

The subject matter disclosed herein generally relates to the processing of data. Specifically, the present disclosure addresses systems and methods involving document processing, document presentation, or both, using retrieval path data.

### BACKGROUND

It is known that a machine may be used to facilitate retrieval of a document. A web server machine may receive a request from a user to retrieve a document stored in a database of the web server machine, and the web server machine may provide the document to a web client machine (e.g., the user's computer) in response to the request. For example, the request may be a click made by the user on a hyperlink displayed in a web page, where the hyperlink references another web page. The web server machine may respond to the click by retrieving the latter web page and providing it to the web client machine.

Moreover, a machine may be used to facilitate a presentation of a document that references a product available for selection by the user. The web server machine may cause an electronic storefront to be displayed in the document, and the electronic storefront may present the available product. If the user is interested in the product, the user may use the electronic storefront to select that product for purchase or to obtain further information about the product.

### BRIEF DESCRIPTION OF THE DRAWINGS

Some embodiments are illustrated by way of example and not limitation in the figures of the accompanying drawings in which:

FIG. 1 is an event diagram illustrating events in a retrieval path of a document, according to some example embodiments;

FIG. 2 is an event diagram illustrating requests included within an intent boundary and requests outside the intent boundary, according to some example embodiments;

FIG. 3 is a diagram illustrating augmentation of a document with event metadata and intent metadata, according to some example embodiments;

FIG. 4 is a diagram illustrating a web page with some event metadata and some intent metadata, according to some example embodiments;

FIG. 5 is a network diagram illustrating a network environment of a document processing and presentation machine, according to some example embodiments;

FIG. 6 is a block diagram illustrating modules of a document processing and presentation machine, according to some example embodiments;

FIG. 7 is a flow chart illustrating a method of document processing using retrieval path data, according to some example embodiments;

FIGS. 8-9 are flowcharts illustrating a method of processing retrieval path data of a document, according to some example embodiments;

FIG. 10 is a flow chart illustrating a method of document presentation using retrieval path data, according to some example embodiments; and

FIG. 11 is a block diagram illustrating components of a machine, according to some example embodiments, able to read instructions from a machine-readable medium and perform any one or more of the methodologies discussed herein.

### DETAILED DESCRIPTION

Example methods and systems are directed to document processing, document presentation, or both, using retrieval path data. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

A user who is browsing through documents (e.g., web pages of a web site) generally has some intent for engaging in the browsing. The user's browsing activity may involve requesting retrieval of one or more documents and, based on a reading of one or more documents, requesting retrieval of further documents. As used herein, “intent” refers to a goal, purpose, objective, or desire that motivates browsing activity. For example, the intent of the user may be to find a recipe for beef noodle soup. As another example, the intent may be to shop for an espresso machine that is simple to clean. In another example, the intent may be to find an inexpensive camera suitable for outdoor photography. As a further example, the intent may be to research potential gifts suitable for a seven-year old niece.

Motivated by the intent of the user, the browsing activity of the user can be viewed as events that constitute a “retrieval path,” which is to say, a path of events leading to, though not necessarily ending with, a retrieval of a particular document that satisfies the user's intent, at least partially if not fully. The events in the retrieval path may include requests for information (e.g., documents, questions, or queries), as well as results of those requests (e.g., document presentation, document denial, answers to questions, or search results). As used herein, “retrieval path data” refers to information that describes a retrieval path. For example, retrieval path data may include event data (e.g., data from one or more events constituting the retrieval path).

Sometimes, the retrieval path may be short or direct, allowing the user to find a satisfactory document quickly. For example, the user may search for an “iPhone,” and the returned search results may include a link to an electronic storefront that sells exactly the kind of iPhone™ desired by the user. If the user clicks on the link and purchases the iPhone™, it may be inferred that the user's intent was to purchase an iPhone™ of that kind The path of events leading to the electronic storefront includes a request, specifically, a request to search for “iPhone,” that led to the retrieval of the electronic storefront.

Other times, the retrieval path may be long or indirect, retrieving the satisfactory document for the user after multiple attempts to seek the document. For example, the user may search for a “tent for burning man,” in contemplation of attending an annual outdoor festival in the Nevada desert known as “The Burning Man.” The search engine, being untrained with respect to this festival, may provide generic results for “tent” or may provide no results at all, thus frustrating the user. The user may persist and modify his search, requesting a second query for a “tent for the desert.” The search engine may then return results useful to the user, such as links (e.g., hyperlinks) to product information in the form of, for example, documents (e.g., product web pages), news articles, consumer reviews, frequently asked questions (FAQs), advertisements, and shopping interfaces (e.g., an electronic storefront), all related to tents usable in desert conditions. The user may request and read several documents (e.g., multiple reviews of tents) before requesting an electronic storefront to purchase a particular tent. In this case, the retrieval path of the electronic storefront includes multiple requests, including the request to search for a “tent for burning man,” that led to the retrieval of the electronic storefront.

By storing a retrieval path as metadata (e.g., metadata relating to events in the retrieval path) of a document, a system, according to some example embodiments, may process the metadata to determine an intent. This intent is inferred from the retrieval path, and the inferred intent may be ascribed to the user. While the system does not purport to read the mind of the user and thereby discover the actual intent contemplated by the user, the system may process an aggregate of retrieval paths from multiple users for multiple documents and infer a statistically likely intent of the user. The inferred intent may be stored by the system as further metadata (e.g., metadata relating to the intent) of the document. The system indexes at least some of the metadata, hence enabling the system to provide the document to another user whose retrieval path intersects with the previously processed retrieval path. Accordingly, the system shortens the retrieval path for the latter user.

In presenting the document to the latter user, the system may also present some of the metadata of the document. For example, the system may generate and provide a web page that includes the document and some metadata. As another example, the system may alter the document to display some of the metadata within the document itself.

Metadata relating to events in the retrieval path is referred to herein as “event metadata.” Metadata relating to inferred intent is referred to herein as “intent metadata.” By presenting the latter user with some event metadata, the system may show the latter user activities performed (e.g., requests made) by other users prior to retrieving the document, as well as links to further documents that the other users subsequently retrieved. In presenting the latter user with some intent metadata, the system may show the latter user one or more intents likely held by other users when retrieving the document. Accordingly, the system may assist the latter user in pursuing his or her actual intent by providing shortcuts to documents ultimately retrieved by the other users in pursuit of their actual intents.

Multiple retrieval paths may be represented within the event metadata, and multiple intents may be represented within the intent metadata. The system may, however, process metadata to identify a single event or a single intent. For example, the system may perform a semantic analysis (e.g., a latent semantic analysis) of event data to determine (e.g., infer) boundaries between individual intents included in a long retrieval path (e.g., event data from a long chain of events). Accordingly, the system may determine that the intent corresponds to a request to retrieve a particular document.

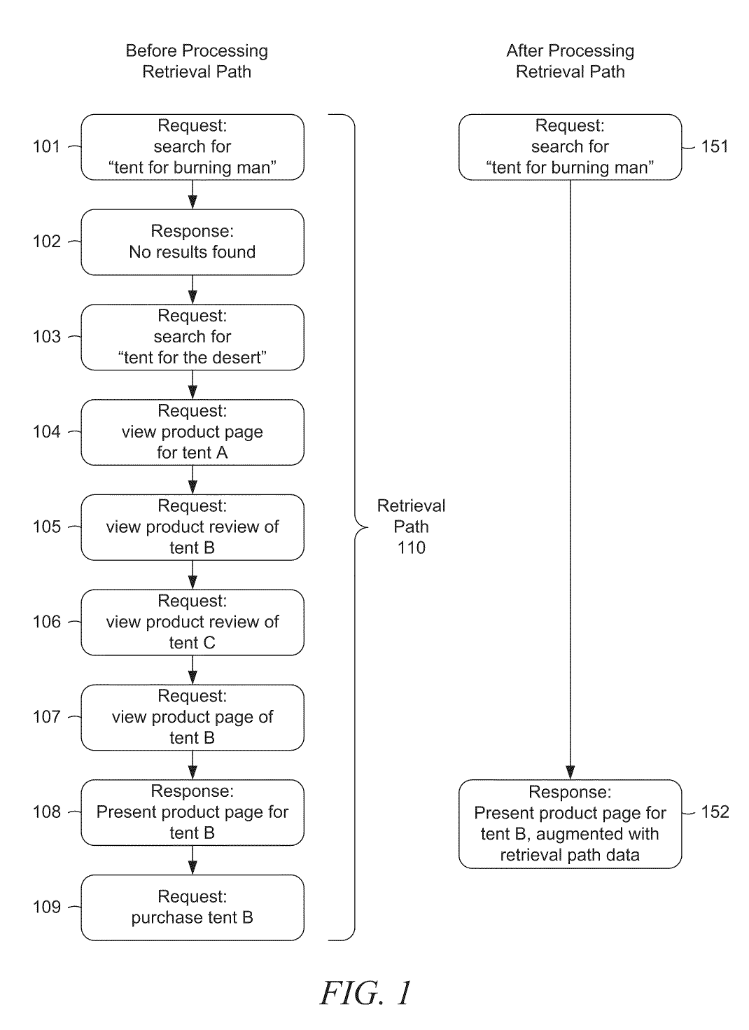

FIG. 1 is an event diagram illustrating events 101-109 in a retrieval path 110 of a document, according to some example embodiments. Also shown are events 151-152. The events 101-109 and 151-152 are ordered in time and are shown in chronological sequence, as indicated by arrows. However, alternative example embodiments may order events using any dimension (e.g., according to mathematically calculated vector distances in an n-dimensional space). Events 101-109 occur prior to processing the retrieval path 110 and are associated with a first user interacting with a network-based publication system from a first client device of the first user (e.g., a computer or a phone). Events 151-152 occur after the processing of the retrieval path 110 and are associated with a second user interacting with the system from a second client device.

Event 101 is a request in which the first user submits a query for a “tent for burning man.” For example, the first user may access a network-based publication system (e.g., an online shopping web server, an inventory control server, or a classified ad web server) and use its search engine to search for “tent for burning man.”

Event 102 is a response in which no results are found. As an example, the network-based publication system may respond to the first user with a message (e.g., in a web page) indicating that the search returned zero results.

Event 103 is a request in which the first user re-formulates his query and submits a new query for a “tent for the desert.” Not shown in FIG. 1 is a response event in which the network-based publication system provides a web page containing several search results in response to event 103. For example, the search results may include links to a product page for “tent A,” a product page for “tent B,” a product review of “tent B,” and a product review of “tent C.”

Event 104 is a request by the first user to view the product page for “tent A.” For example, the first user may click on a link that references the product page for “tent A.” Event 105 is a request by the first user to view the product review of “tent B;” and event 106 is a request to view the product review of “tent C.” Not shown in FIG. 1 are responses to these requests, in which the network-based publication system provides the requested information (e.g., the product review of “tent B”).

Event 107 is a request by the first user to view the product page for “tent B,” and event 108 is a response in which the network-based publication system presents the product page for “tent B” to the first user. Notably, event 109 is a request by the first user to purchase “tent B.” For example, event 109 may be a request submitted via an electronic storefront to initiate a purchase transaction for a specimen of “tent B.” As another example, event 109 may be a confirmation of such a request. Accordingly, event 109 is a “positive event,” which is to say, an event that indicates an affirmation of the first user's intent. Specifically, the network-based publication system may infer from events 101-109 that the first user intended to purchase a particular kind of tent, namely, a kind of tent satisfied by “tent B.” After requesting two searches and four documents, the first user purchased the product is shown in one particular document, the product page for “tent B.” Thus, the retrieval path 110 may be associated with the product page for “tent B” (e.g., as event metadata) for future use with respect to other users.

Within the retrieval path 110, several requests are for retrieval of documents devoid of any reference to “tent B.” For example, event 101 requested a search that returned no results, and hence makes no mention of “tent B.” As another example, event 104 requested a product page for a different tent (“tent A”). Yet these requests are included in the retrieval path 110 as indicative of the first user's browsing behavior while pursuing his intent to purchase a tent.

Events 151 and 152 occur after the processing of the retrieval path 110. The processing of the retrieval path 110 associates the retrieval path 110 with a particular document, namely, the product page for “tent B.” For example, the retrieval path 110 may be stored as event metadata of the product page for “tent B,” and the event metadata may be indexed to facilitate identification of the product page for “tent B” in future searches. As noted above, the events 151 and 152 are associated with the second user interacting with the network-based publication system from the second client device (e.g., a computer or a phone).

Event 151 is a request in which the second user submits a query for a “tent for burning man,” similar to the first user's request in event 101. With the retrieval path 110 now stored as event metadata of the product page for “tent B,” the network-based publication system no longer responds with zero results, as in event 102. Instead, the system responds to the second user with a document likely to satisfy the inferred intent motivating a search for a “tent for burning man.” In other words, the system ascribes this intent to the second user and selects the product page for “tent B” for presentation to the second user.

Event 152 is a response in which the network-based publication system presents the product page for “tent B” to the second user. Additionally, in event 152, the product page for “tent B” is augmented with retrieval path data (e.g., event metadata or intent metadata). For example, the product page may be supplemented with a system-generated statement that the first user also searched for a “tent for burning man” and ultimately purchased “tent B.” Thus, the second user may experience a more direct and satisfying fulfillment of his actual intent.

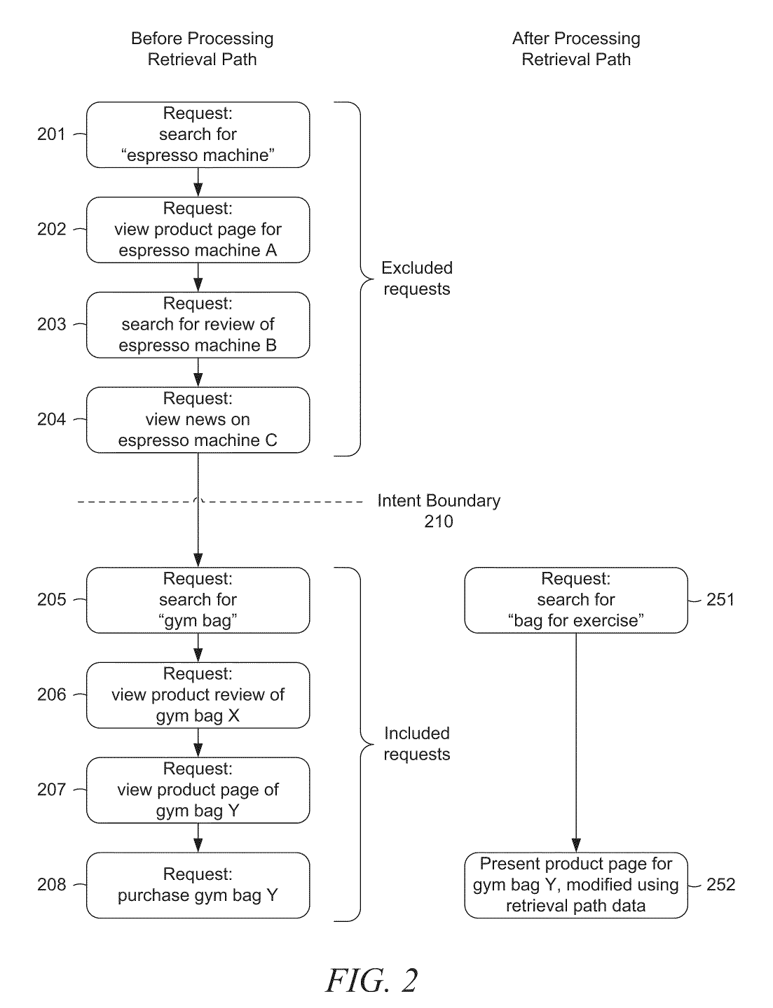

FIG. 2 is an event diagram illustrating requests 205-208 included within an intent boundary 210 and requests 201-204 outside the intent boundary 210, according to some example embodiments. Also shown are events 251 and 252. The events 201-208 and 251-252 are ordered in time and shown in chronological sequence, as indicated by arrows. However, alternative embodiments may order events using any dimension. Events 201-208 occur prior to processing of events 205-208, and are associated with a first user interacting with a network-based publication system from a first client device of the first user (e.g., a computer or a phone). Events 251-252 occur after the processing of events 205-208 and are associated with a second user interacting with the system from a second client device.

Events 201-208 constitute a retrieval path that expresses multiple intents (e.g., two intents). Event 201 is a request in which the first user submits a query for an “espresso machine.” Not shown in FIG. 2 is a response event in which the system provides a web page containing several search results in response to event 201. For example, the search results may include links to product information for various espresso machines.

Event 202 is a request by the first user to view a product page for “espresso machine A” (e.g., an advertisement, a description, or technical specifications). Event 203 is a request by the first user to search for a product review of “espresso machine B” (e.g., a professional review, an amateur review, consumer poll results, a ranked “top-ten” list, or an aggregate rating). Event 204 is a request by the first user to view the product news pertaining to “espresso machine C” (e.g., consumer safety news, product recall news, or celebrity endorsement news).

Event 205 is a request in which the first user searches for a new topic unrelated to espresso machines, namely, a “gym bag.” Not shown in FIG. 2 is a response event in which the system provides search results in response to event 205. For example, the search results may include links to product information for various gym bags (e.g., sports bags, exercise bags, duffel bags, or athletic bags).

Event 206 is a request by the first user to view a product review of “gym bag X.” Event 207 is a request by the first user to view a product page describing “gym bag Y.” Event 208 is a request by the first user to purchase “gym bag Y,” and accordingly, event 208 is a positive event that indicates an affirmation of the first user's intent. Similar to event 109, event 208 may be a submission via an electronic storefront to commit the first user to a purchase transaction.

Events 201-204 relate to espresso machines, while events 205-208 relate to gym bags. Accordingly, one intent (e.g., shopping for an espresso machine) may be inferred from events 201-204 and ascribed to the first user, and another intent (e.g., shopping for a gym bag) may be inferred from events 205-208 and ascribed to the first user. Using one or more semantic analysis techniques (e.g., latent semantic analysis), a network-based publication system may determine the intent boundary 210 that separates the former intent from the latter intent within a given retrieval path (e.g., events 201-208). Once the intent boundary 210 has been determined, the system includes the events associated with a particular intent (e.g., events 205-208 as indicative of shopping for a gym bag) as event metadata to be associated with the product page of “gym bag Y.” The system, however, excludes events 201-204 from the event metadata, because the excluded events indicate an unrelated intent (e.g., shopping for an espresso machine). The system then stores the event metadata with the product page of “gym bag Y” (e.g., in a common database). The system further may index the event metadata to enable efficient retrieval of the product page based on the event metadata.

Furthermore, the system generates intent metadata to be associated with the product page of “gym bag Y.” For example, the system may generate one or more text phrases, such as “gym bag,” “bag for gym,” “bag for working out,” “bag for exercising,” and “bag for exercise class” as the intent metadata. The system may then store the intent metadata with the product page of “gym bag Y” (e.g., in the common database). The intent metadata may be generated based on a semantic analysis of requests (e.g., events 205-208) submitted by one or more users (e.g., the first user). The system may also index the intent metadata to enable efficient retrieval of the product page based on the intent metadata.

Events 251 and 252 occur after the processing of events 205-208 to associate the event metadata and the intent metadata with the product page of “gym bag Y.” Event 251 is a request in which a second user submits a query for a “bag for exercise.” Based on the event metadata, the intent metadata, or both, the network-based publication system selects the product page for “gym bag Y” for presentation to the second user.

Event 252 is a response in which the system presents the product page for “gym bag Y” to the second user. Similar to event 152, in events 252, the system may present some retrieval path data (e.g., event metadata, intent metadata, or both) to augment the product page for “gym bag Y.” For example, the product page may be supplemented with a machine-generated statement that the first user searched for a “gym bag” and eventually purchased “gym bag Y.” This may have the effect of saving the second user the time and inconvenience of reviewing the product review of “gym bag X,” resulting in a more direct and satisfying fulfillment of his intent.

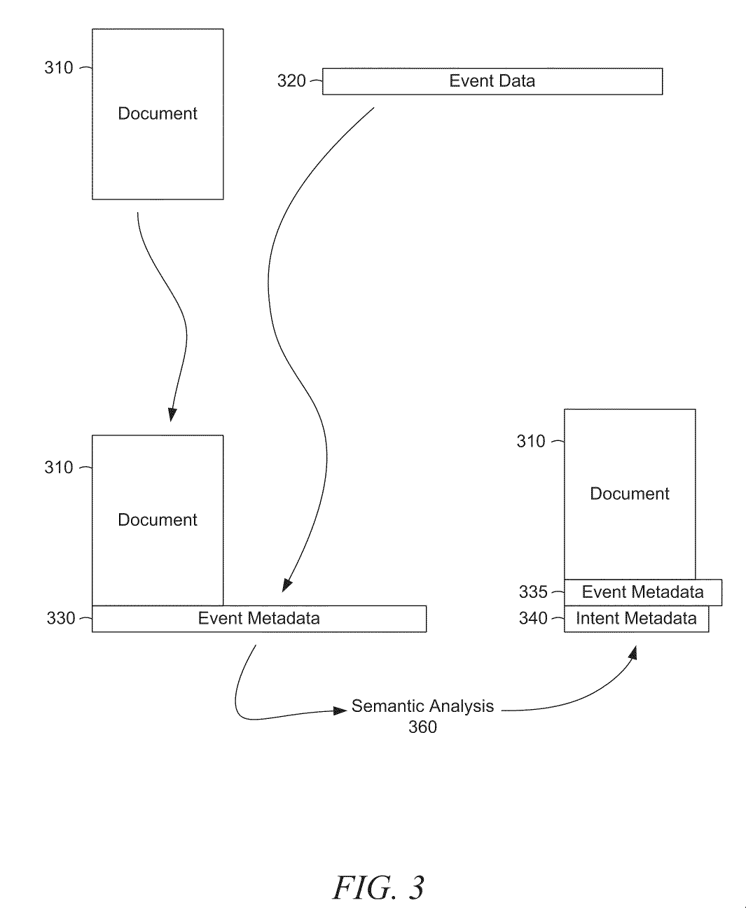

FIG. 3 is a diagram illustrating augmentation of a document 310 with event metadata 335 and intent metadata 340, according to some example embodiments. Event data 320 represents one or more requests made by a user (e.g., a first user) to a network-based publication system. The requests include a request to retrieve the document 310.

The document 310 is a document available from the networked-based publication system. The document 310 may be, or include: a listing of an item available for sale (e.g., a specimen of a product available for sale), an electronic storefront that is operable by a user (e.g., the first user) to initiate a purchase of the item, a description of the product available for sale, a review of the product, a buying guide that references the product, a question pertinent to the product (e.g., a frequently asked question (FAQ)), an answer to the question, or any suitable combination thereof.

In addition to the request to retrieve the document 310, the event data 320 may also include: a request to execute a query generated by a user (e.g., the first user), a request to view a search result provided to a client device by the network-based publication system (e.g., in response to the query), a request to view a page devoid of references to an item available for sale that is referenced by the document 310 (e.g., a web page unrelated to the item available for sale), a request to initiate a purchase of the item (e.g., a purchase confirmation), or any suitable combination thereof.

A request to initiate a purchase of the item may be the final request in a sequence of requests ordered in time, but such a request need not be the final request in all example embodiments. Furthermore, the event data 320 may include one or more timestamps corresponding respectively to one or more requests. For example, a request to view a product page may include a timestamp indicating when the user submitted the request to the network-based publication system.

As shown by arrows in FIG. 3, the document 310 and the event data may be combined together (e.g., by a document processing and presentation machine within the network-based publication system), and the event data 320 may become event metadata 330 of the document 310. The document 310 may be stored with the event metadata 330. For example, a document processing and presentation machine within the network-based publication system may store the document 310 and the event metadata 330 in a database of the networked-based publication system.

The document processing and presentation machine may perform a semantic analysis 360 of the event metadata 330. Based on the semantic analysis 360, the machine may modify (e.g., truncate) the event metadata 330 to obtain a portion 335 of the event data 330 (e.g., a portion limited to events representing a single intent). Moreover, the document processing and presentation machine may determine intent metadata 340 based on the event metadata 330. The portion 335 of the event metadata 330 and the intent metadata 340 may be stored with a document (e.g., by the document processing and presentation machine) in a database. Furthermore, the portion 335 of the event metadata 330, the intent metadata 340, or both, may be indexed to facilitate retrieval of the document 310. For example, the document processing and presentation machine may perform the indexing to optimize retrieval of the document 310 based on some of the event metadata 335, some of the intent metadata 340, or any suitable combination thereof.

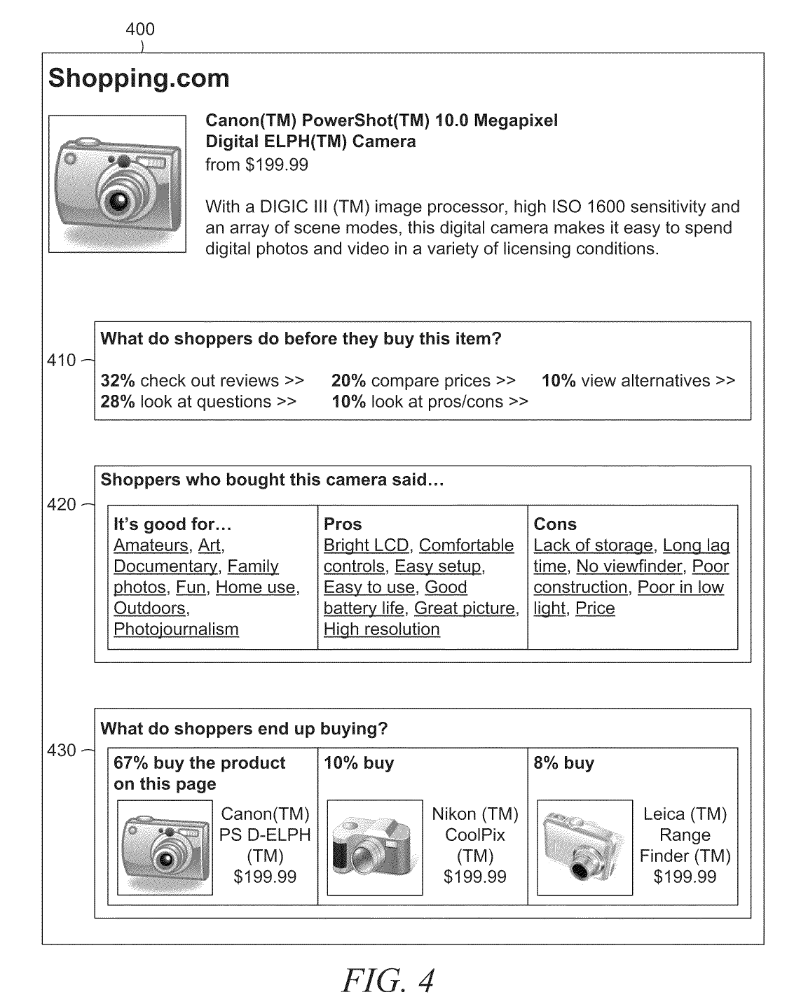

FIG. 4 is a diagram illustrating a web page 400 with some event metadata 410 and 430 and some intent metadata 420, according to some example embodiments. The web page 400 is an example of a document available from a network-based publication server. In particular, the web page 400 is a product page for a digital camera (e.g., a “Canon™ Powershot™ 10.0 Megapixel Digital ELPH™ camera”) and hence includes some information describing the digital camera.

Event metadata 410 is an aggregate of event data (e.g., requests for documents) from multiple users. The event metadata 410 indicates statistical behavior of other users who ultimately purchased this digital camera. For example, the event metadata 410 indicates that 32% of the users requested a product review (e.g., of this digital camera), while 10% of the users requested product information (e.g., product pages) of alternatives (e.g., other digital cameras).

Event metadata 430 is an aggregate of event data (e.g., requests to purchase items) from multiple users. The event metadata 430 indicates statistical behavior of other users in purchasing digital cameras. For example, the event metadata 430 indicates that 67% of the users chose to purchase this digital camera, while 10% of the users chose to purchase a different digital camera (e.g., a “Nikon™ CoolPix™” camera).

Intent metadata 420 is an aggregate of intent metadata generated based on the event data from the multiple users. The intent metadata 420 includes machine-generated statements describing contexts (e.g., conditions) suitable for this digital camera. For example, the intent metadata 420 includes the statement, “It's good for . . . Amateurs.” The intent metadata 420 also includes machine-generated statements describing positive features of this digital camera (e.g., “Pros . . . Bright LCD.”). The intent metadata 420 further includes machine-generated statements describing negative features of this digital camera (e.g., “Cons . . . Lack of storage.”). These statements do not need to be machine-generated. Any one or more of the statements may be generated by a user and used in the intent metadata 420. As an example, the event data from the multiple users may include requests by some of the users to submit a statement (e.g., a comment) pertaining to this digital camera. Accordingly, the intent metadata 420 may be based on inferred intent (e.g., as described herein), explicit intent (e.g., as submitted by users), or any suitable combination thereof.

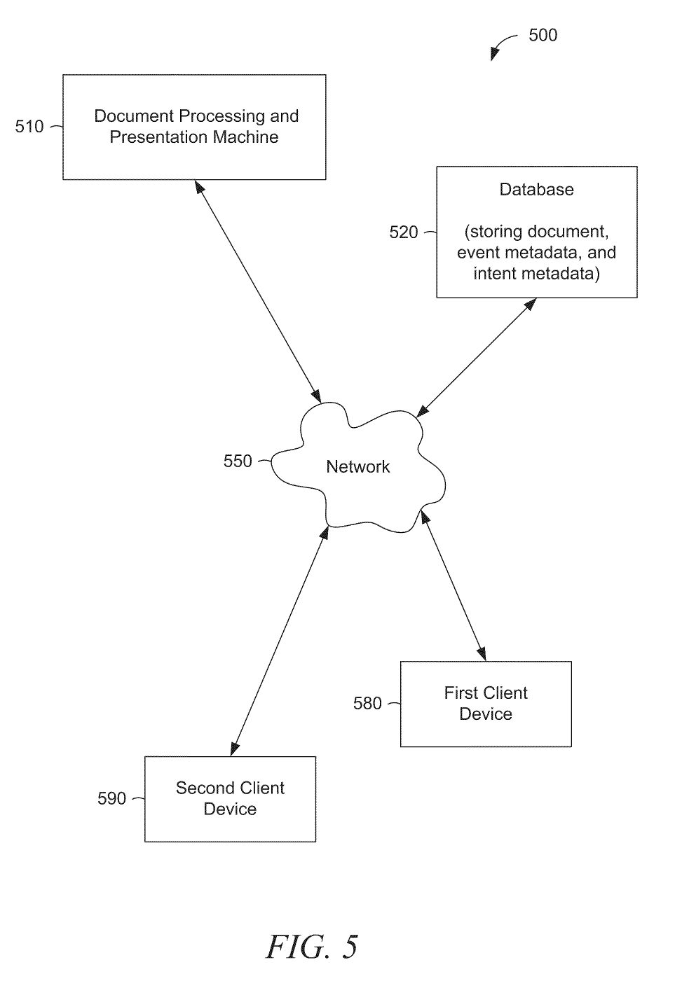

FIG. 5 is a network diagram illustrating a network environment 500 of a document processing and presentation machine 510, according to some example embodiments. The network environment 500 includes the document processing and presentation machine 510, a database 520, a first client device 580, and the second client device 590, all connected to a network 550 and configured to communicate with each other via the network 550.

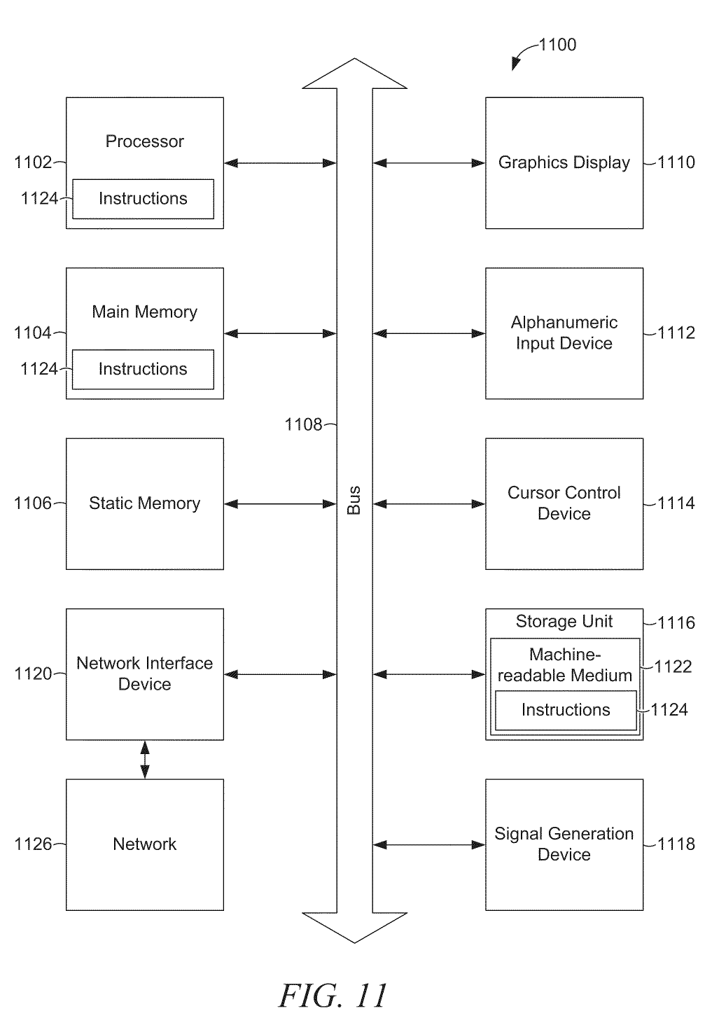

The document processing and presentation machine 510 includes a processor and may be implemented using a computer that has been programmed by software, resulting in a special-purpose computer to perform document processing and presentation using retrieval path data. An example of physical structures of a general-purpose computer is described below with respect to FIG. 11.

The database 520 is a repository of data and stores information on a machine-readable storage medium. The database 520 may be a database server machine (e.g., a server computer) and may store documents (e.g., document 310) with their associated event metadata (e.g., event metadata 410 and 430) and intent metadata (e.g., intent metadata 420).

The network 550 may be any network that enables communication between machines (e.g., the document processing and presentation machine 510 and the first client device 580). Accordingly, the network 550 may be a wired network, a wireless network, or any suitable combination thereof. The network 550 may include one or more portions that constitute a private network, a public network (e.g., the Internet), or any suitable combination thereof.

The first client device 580 is associated with a first user and may be a machine of the first user (e.g., a personal computer, a cellular phone, or a web appliance). The second client device 590 is associated with a second user and may be a machine of the second user.

Any of the machines shown in FIG. 5 may be implemented using a general-purpose computer modified (e.g., programmed) by special-purpose software to be a special-purpose computer to perform the functions described herein for that machine. For example, a computer system able to implement any one or more of the methodologies described herein is discussed below with respect to FIG. 11. Moreover, any two or more of the machines illustrated in FIG. 5 may be combined into a single machine, and the functions described herein for a single machine may be subdivided among multiple machines.

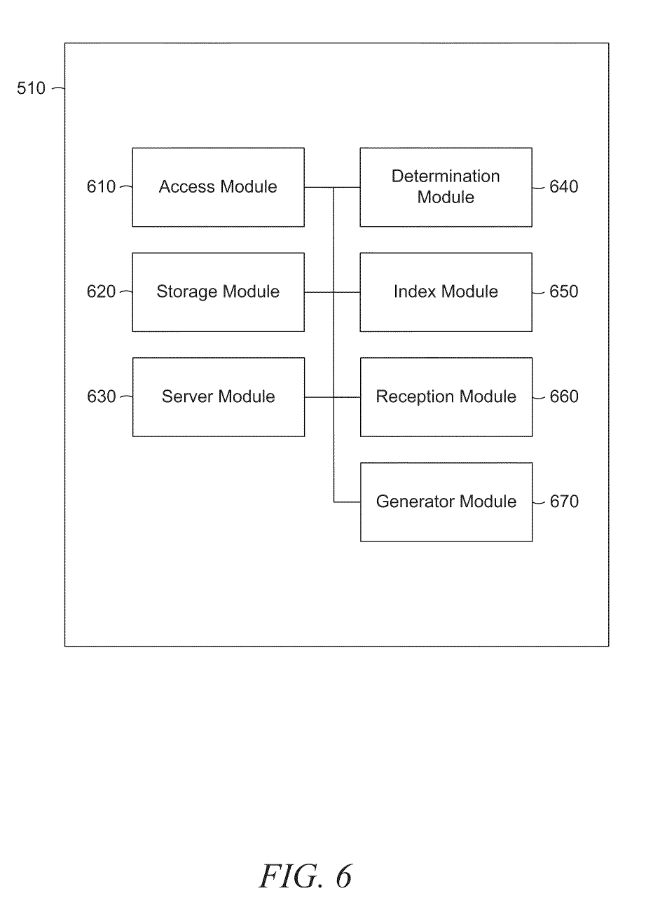

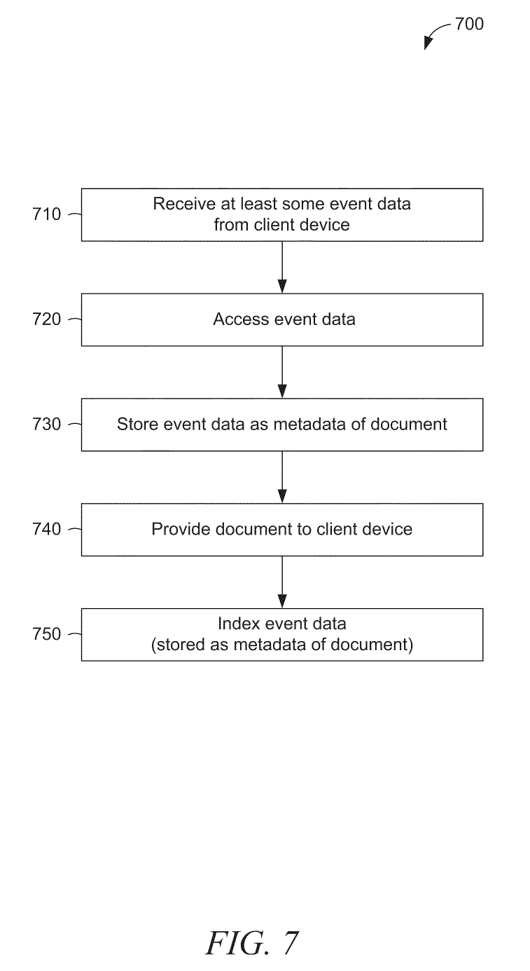

FIG. 6 is a block diagram illustrating modules of a document processing and presentation machine 510, according to some example embodiments. The document processing and presentation machine 510 includes an access module 610, a storage module 620, a server module 630, a determination module 640, and an index module 650, a reception module 660, and a generator module 670, all configured to communicate with each other (e.g., via a bus, a shared memory, or a switch). Any of these modules may be implemented using hardware, as described below with respect to FIG. 11. Moreover, any two or more of these modules may be combined into a single module, and the functions described herein for a single module may be subdivided among multiple modules. The functionality of modules 610-670 is described below with respect to FIGS. 7-10.

FIG. 7 is a flow chart illustrating a method 700 of document processing using retrieval path data, according to some example embodiments. The method 700 includes operations 710-750.

At operation 710, the reception module 660 receives at least some of the event data 320 from the first client device 580 (e.g., from the first user). As noted above, the event data 320 represents one or more requests, at least one of which is a request to retrieve the document 310 (e.g., event 207, the request to view the product page of “gym bag Y”). For example, the first client device 580 may collect the event data 320 over a period of time (e.g., one hour, or one day) and upload the event data 320 to the document processing and presentation machine 510. As another example, the document processing and presentation machine 510 may monitor communications from the first client device 580 to the network-based publication system and accordingly accumulate the event data 320 request by request.

In conjunction with operation 710, the determination module 640 may filter requests (e.g., events 201-207) received from the first client device 580 to limit the event data 320. The determination module 640 may filter the requests based on a period of time (e.g., selecting only those requests made by the user during the period of time). The determination module may filter the requests based on a total number of requests to be included in the event data 320 (e.g., selecting only the most recent 100 requests made by the user).

At operation 720, the access module 610 accesses the event data 320 (e.g., by accessing the database 520, or by reading the event data 320 from a computer memory). As noted above, the event data 320 includes a request to retrieve the document 310 (e.g., event 207, the request to view the product page of “gym bag Y”).

At operation 730, the storage module 620 stores the event data 320 as event metadata 330 (e.g., event metadata 410) of the document 310. For example, the storage module 620 may store the event metadata 330 as a file linked to the document 310 in the database 520. As another example, the storage module 620 may write the event metadata 330 into a document header of the document 310.

At operation 740, the server module 630 provides the document 310 to the first client device 580 in response to the request to retrieve the document 310 (e.g., event 207). The server module 630 may be a web server module and serve the document 310 using any Internet protocol (e.g., Hypertext Transfer Protocol (HTTP)).

At operation 750, the index module 650 indexes the event data 320 stored as the event metadata 330 in the database 520. The index module 650 may use any indexing algorithm to perform operation 750.

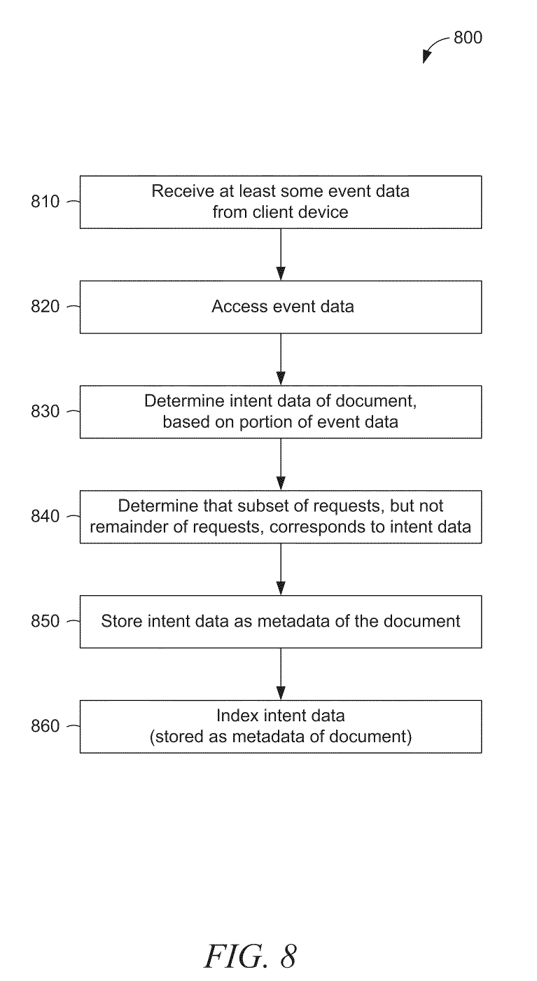

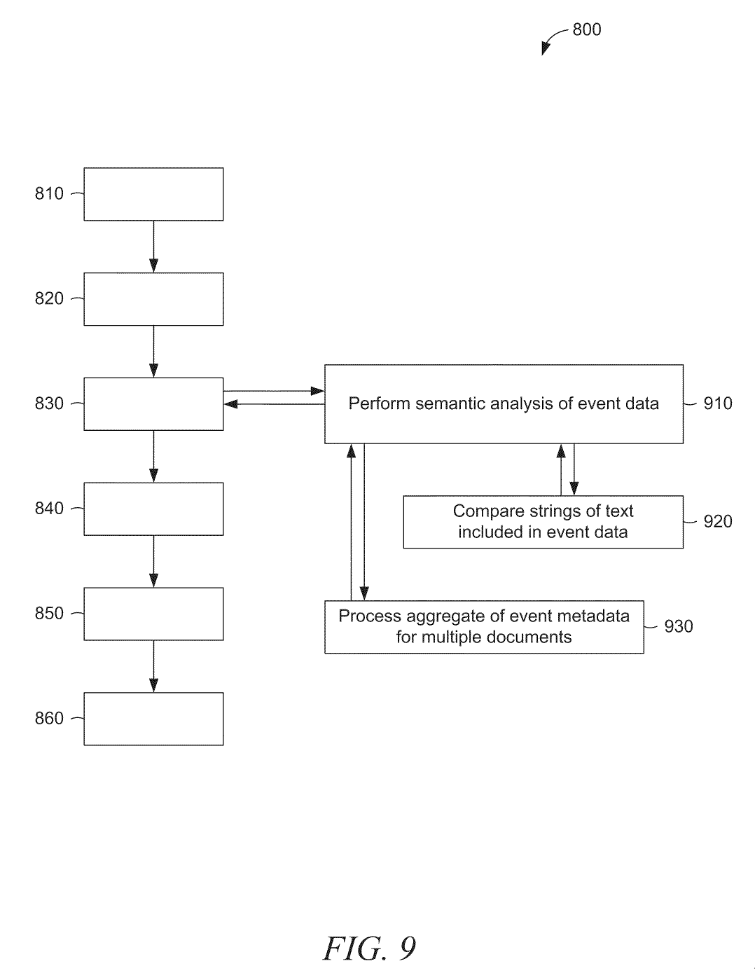

FIGS. 8-9 are flowcharts illustrating a method 800 of processing retrieval path data of a document, according to some example embodiments. The method 800 includes operations 810-860 and operations 910-930.

At operation 810, the reception module 660 receives at least some of the event data 320 from the first client device 580. This may be performed in a manner similar to operation 710 of method 700.

At operation 820, the access module 610 accesses the event data 320. This may be performed in a manner similar to operations 720 of method 700. Additionally, the event data 320 may be stored (e.g., by the storage module 620) in the database 520 as the event metadata 330 of the document 310. Accordingly, the access module 610 may access (e.g., read from the database 520) the event metadata 330 to access the event data 320.

At operation 830, the determination module 640 determines the portion 335 of the event metadata 330 and determines intent data based on the portion 335. For example, the determination module 640 may modify (e.g., truncate) the event metadata 330 to determine the portion 335. The determination of the portion 335 may be based on the semantic analysis 360 of the event metadata 330. As noted above, the portion 335 includes a request (e.g., event 207) to retrieve the document 310. Based on the portion 335 of the event metadata 330, the determination module 640 determines the intent data. For example, the determination module 640 may extract textual information (e.g., keywords) from the portion 335 that are statistically likely to indicate an intent ascribable to the user (e.g., the first user).

From operation 830, the method 800 proceeds to operation 910. Operation 910 involves performing a semantic analysis of the event metadata 330. For example, the semantic analysis may be a latent semantic analysis.

The semantic analysis may include operation 920, which involves performing a comparison of textual information (e.g., text data) included in the event metadata 330. For example, the determination module 640 may compare the phrase “espresso machine” (e.g., from event 201) to the phrase “gym bag” (e.g., from the event 205) in performing the semantic analysis.

The semantic analysis may include operation 930, which involves processing an aggregate of event metadata (e.g., event metadata 330) for multiple documents (e.g., document 310). The aggregate of event metadata may be received (e.g., by the reception module 660) from multiple client devices (e.g., the second client device 590) associated with multiple users (e.g., the second user). For example, the reception module 660 may accumulate the aggregate over a period of time (e.g., three months), and the determination module may process the simulated aggregate at the end of the period.

At operation 840, the determination module 640 determines the intent boundary 210 and accordingly determines that a subset of the events (e.g., requests) represented in the event metadata 330 correspond to the intent data and that the remainder of the events do not correspond to the intent data. The subset of the events is represented by the portion 335 of the event metadata 330.

Operations 830 and 840 may be performed by the determination module 640 iteratively. For example, the determination module 640 may initially estimate the intent boundary 210 using operation 830 and performed the semantic analysis 360 to determine the intent boundary 210. Alternatively, the determination module 640 may determine intent data for all of the event metadata 330 and accordingly determine the intent boundary 210 as a boundary of the portion 335, thus defining the intent boundary 210 and the portion 305 contemporaneously.

At operation 850, the storage module stores the intent data in the database 520 as the intent metadata 340 (e.g., intent metadata 420) of the document 310. For example, the storage module 620 may store the intent metadata 340 as a file linked to the document 310 in the database 520. As another example, the storage module 620 may write the intent metadata 340 into the document header of the document 310.

At operation 860, the index module 650 indexes the intent data stored as the intent metadata 340 in the database 520. The index module 650 may use any indexing algorithm to perform operation 860.

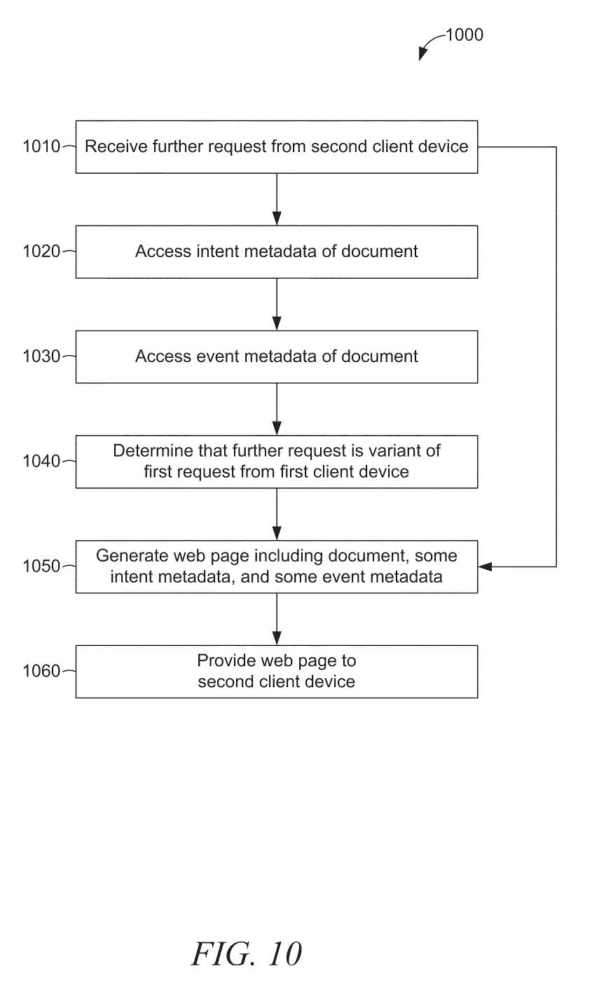

FIG. 10 is a flow chart illustrating a method 1000 of document presentation using retrieval path data, according to some example embodiments. The method 1000 includes operations 1010-1060.

In the context of the method 1000, the document 310 has been augmented using retrieval path data from a first user of the first client device 580. Methods 700 and 800 have been performed as described above. The document 310 has been stored in the database 520 with the portion 335 of the event metadata 330 and with the intent metadata 340. The document 310 and its metadata have been indexed by the index module 650. Accordingly, the retrieval path data is available for use by another user (e.g., a further user). For example, a second user of the second client device 590 may submit a new request (e.g., a further request) to the network-based publication system. Event 251 is an example of such a new request. Within the network-based publication system, the document processing and presentation machine 510 responds to the new request and uses the retrieval path data (e.g., the portion 335 of the event metadata 330, or the intent metadata 340) to select the document 310 for presentation to the second user.

At operation 1010, the reception module 660 receives the new request from the second client device 590. This may be performed in a manner similar to operation 710 of method 700.

At operation 1020 the access module 610 accesses the intent metadata 340 of the document 310. At operation 1030, the access module 610 accesses the portion 335 of the event metadata 330 of the document 310. Operation 1020, operation 1030, or both, may be performed in a manner similar to operation 720 of method 700. In the context of method 1000, the portion 335 includes a first request (e.g., event 207) made by the first user to retrieve the document 310 (e.g., the product page for “gym bag Y”) to the first client device 580.

At operation 1040, the determination module 640 determines that the new request (e.g., event 251, the request to search for “gym bag”) made by the second user is a variant of the first request (e.g., event 207, the request to search for “bag for exercise”) made by the first user. This determination may be made based on the intent metadata 340, the portion 335 of the event metadata 330, or both. In alternative example embodiments, the determination module 640 determines that the new request is the same as the first request (e.g., the new request is a request for a search that uses the same search terms as the first request).

In some example embodiments, the new request is similar to the first request, differing only in time (e.g., timestamp) and in destination. For example, where the first request was a request to retrieve a body of information to the first client device 580 on a Monday, the new request may be a request to retrieve the same body of information to the second client device 590 on the following Tuesday.

At operation 1050, the generator module 670 generates a web page (e.g., web page 400) that includes the document 310, some intent metadata (e.g., intent metadata 420), and some event metadata (e.g., event metadata 410). The effect of this is to allow the second user to view some retrieval path data when viewing the document 310.

At operation 1060, the server module 630 provides the generated web page (e.g., web page 400) to the second client device 590 in response to the determination performed in operation 1040. The server module 630 may be a web server module and serve the web page in a manner similar to providing the document 310 in operation 740 of method 700. Accordingly, the second user is presented with the document 310, augmented with retrieval path data, without having to follow the retrieval path of the first user.

In some example embodiments, the method 1000 proceeds directly from operation 1010 to operation 1050. In operation 1010, the reception module 660 may receive the new request from the second client device 590, and the new request may be a straightforward request to retrieve the document 310. For example, a third-party web site may recommend the document 310 to its users and provide a direct hyperlink to the document 310, which is being served by the network-based publication system (e.g., the server module 630 of the document processing and presentation machine 510). From operation 1010, as indicated by an arrow in FIG. 10, the method 1000 proceeds to operation 1050, in which the generator module 670 generates the web page (e.g., web page 400). In generating the web page, the generator module 670 may access the database 520 and accordingly perform operation 1020, operation 1030, or both. According to various example embodiments, the generator module 670 may cause the access module 610 to perform operation 1020, operation 1030, or both.

In some alternate example embodiments, the web page may have been previously generated by the generator module 670 and stored by the storage module 620 for future use (e.g., in a cache memory, or in the database 520). The method 1000 may proceed directly from operation 1010 to operation 1060, in which the server module 630 provides the web page to the second client device 590.

In various example embodiments, one or more of the methodologies described herein may facilitate an enhanced user experience for the second user by reducing time, effort, computing resources, network traffic, power usage, or any combination thereof, associated with browsing activities of the second user. By using retrieval path data to infer an intent likely to have motivated the first user's request to retrieve the document 310, the document processing and presentation machine 510 correlates a likely intent of the first user with a likely intent of the second user. The document processing and presentation machine 510 accordingly offers the second user a shortcut that abbreviates the retrieval path of the first user and leads the second user directly to the document 310. Thus, the second user may be able to satisfy his intent with significantly less browsing activity (e.g., requests) compared to the first user. Moreover, all subsequent users may gain similar benefits.

FIG. 11 illustrates components of a machine 1100, according to some example embodiments, that is able to read instructions from a machine-readable medium (e.g., machine-readable storage medium) and perform any one or more of the methodologies discussed herein. Specifically, FIG. 11 shows a diagrammatic representation of the machine 1100 in the example form of a computer system and within which instructions 1124 (e.g., software) for causing the machine 1100 to perform any one or more of the methodologies discussed herein may be executed. In alternative embodiments, the machine 1100 operates as a standalone device or may be connected (e.g., networked) to other machines. In a networked deployment, the machine 1100 may operate in the capacity of a server machine or a client machine in a server-client network environment, or as a peer machine in a peer-to-peer (or distributed) network environment. The machine 1100 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 1124 (sequentially or otherwise) that specify actions to be taken by that machine. Further, while only a single machine is illustrated, the term “machine” shall also be taken to include a collection of machines that individually or jointly execute the instructions 1124 to perform any one or more of the methodologies discussed herein.

The machine 1100 includes a processor 1102 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1104, and a static memory 1106, which are configured to communicate with each other via a bus 1108. The machine 1100 may further include a graphics display 1110 (e.g., a plasma display panel (PDP), a liquid crystal display (LCD), a projector, or a cathode ray tube (CRT)). The machine 1100 may also include an alphanumeric input device 1112 (e.g., a keyboard), a cursor control device 1114 (e.g., a mouse, a touchpad, a trackball, a joystick, a motion sensor, or other pointing instrument), a storage unit 1116, a signal generation device 1118 (e.g., a speaker), and a network interface device 1120.

The storage unit 1116 includes a machine-readable medium 1122 on which is stored the instructions 1124 (e.g., software) embodying any one or more of the methodologies or functions described herein. The instructions 1124 may also reside, completely or at least partially, within the main memory 1104, within the processor 1102 (e.g., within the processor's cache memory), or both, during execution thereof by machine 1100. Accordingly, the main memory 1104 and the processor 1102 may be considered as machine-readable media. The instructions 1124 may be transmitted or received over a network 1126 (e.g., network 550) via the network interface device 1120.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1122 is shown in an example embodiment to be a single medium, the term “machine-readable medium” should be taken to include a single medium or multiple media (e.g., a centralized or distributed database, or associated caches and servers) able to store instructions (e.g., instructions 1124). The term “machine-readable medium” shall also be taken to include any medium that is capable of storing instructions (e.g., software) for execution by the machine, such that the instructions, when executed by one or more processors of the machine (e.g., processor 1102), cause the machine to perform any one or more of the methodologies described herein. The term “machine-readable medium” shall accordingly be taken to include, but not be limited to, a data repository in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an application-specific integrated circuit (ASIC). A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A computer-implemented method comprising:
accessing event metadata of a document that is available from a network-based publication system communicatively coupled to a first client device of a first user, the event metadata being representative of a plurality of requests made by the first user to the network-based publication system, the plurality including first and second requests, the second request of the plurality being a request to retrieve the document;
determining that a further request made by a second user is a variant of the first request made by the first user, the further request being made to the network-based publication system from a second client device of the second user; and
providing the document to the second client device in response to the determining that the further request is a variant of the first request, the providing of the document to the second client device being performed by a module implemented using a processor of a machine.

2. The computer-implemented method of claim 1 further comprising
accessing intent metadata of the document; wherein:
the intent metadata is stored in a database and is representative of an intent ascribable to the first user; and
the determining is based on the intent metadata.

3. The computer-implemented method of claim 2, further comprising
generating a web page that includes at least some of the intent metadata of the document; and
providing the web page to the second client device.

4. The computer-implemented method of claim 1, further comprising
generating a web page that includes at least some of the event metadata of the document; and
providing the web page to the second client device.

5. The computer-implemented method of claim 1, wherein:
the plurality of requests is a sequence of requests ordered in time;
the event metadata of the document includes a plurality of timestamps; and
each timestamp of the plurality of timestamps respectively corresponds to one request of the plurality of requests.

6. The computer-implemented method of claim 1, wherein
the plurality of requests includes a request to execute a query generated by the first user.

7. The computer-implemented method of claim 1, wherein
the plurality of requests includes a request to view a search result provided to the first client device by the network-based publication system in response to a query generated by the first user.

8. The computer-implemented method of claim 1, wherein:
the document includes a reference to an item available for sale; and
the plurality of requests includes a request to view a page devoid of references to the item.

9. The computer-implemented method of claim 1, wherein:
the document includes a reference to an item available for sale; and
the plurality of requests includes a request to initiate a purchase of the item.

10. The computer-implemented method of claim 9, wherein:
the plurality of requests is a sequence of requests ordered in time; and
the request to initiate the purchase of the item is a final request within the plurality of requests.

11. The computer-implemented method of claim 1, wherein
the document includes at least one of:
a listing of an item available for sale, the item being a specimen of a product;
an electronic storefront operable by the second user to initiate a purchase the item;
a description of the product;
a review of the product;
a buying guide that references the product;
a question pertinent to the product; or
an answer to the question.

12. The computer-implemented method of claim 1, wherein:
the first request is a request to retrieve a body of information to the first client device; and
the further request is a request to retrieve the body of information to the second client device.

13. The computer-implemented method of claim 1, wherein:
the first request is at least one of:
a request to execute a first query generated by the first user, or
a request to view a search result provided to the first client device by the network-based publication system in response to a query generated by the first user; and
the further request is at least one of:
a request to execute a second query generated by the second user, or
a request to view the search result.

14. A system comprising:
an access module to access event metadata of a document that is available from a network-based publication system communicatively coupled to a first client device of a first user, the event metadata being representative of a plurality of requests made by the first user to the network-based publication system, the plurality including first and second requests, the second request of the plurality being a request to retrieve the document;
a hardware-implemented determination module to determine that a further request made by a second user is a variant of the first request made by the first user, the further request being made to the network-based publication system from a second client device of the second user; and
a server module to provide the document to the second client device in response to the further request being determined to be a variant of the first request.

15. The system of claim 14, wherein:
the access module is to access intent metadata of the document;
the intent metadata is stored in a database and is representative of an intent ascribable to the first user; and
the hardware-implemented determination module is to determine that the further request is a variant of the first request based on the intent metadata.

16. The system of claim 15, wherein
the server module is to generate a web page that includes at least some of the intent metadata of the document and provide the web page to the second client device.

17. The system of claim 14, wherein
the server module is to generate a web page that includes at least some of the event metadata of the document and provide the web page to the second client device.

18. The system of claim 14, wherein
the document includes at least one of:
a listing of an item available for sale, the item being a specimen of a product;
an electronic storefront operable by the second user to initiate a purchase the item;
a description of the product;
a review of the product;
a buying guide that references the product;
a question pertinent to the product; or
an answer to the question.

19. A machine-readable storage medium comprising instructions that, when executed by one or more processors of a machine, cause the machine to perform a method comprising:
accessing event metadata of a document that is available from a network-based publication system communicatively coupled to a first client device of a first user, the event metadata being representative of a plurality of requests made by the first user to the network-based publication system, the plurality including first and second requests, the second request of the plurality being a request to retrieve the document;
determining that a further request made by a second user is a variant of the first request made by the first user, the further request being made to the network-based publication system from a second client device of the second user; and
providing the document to the second client device in response to the determining that the further request is a variant of the first request.

20. The machine-readable storage medium of claim 19, wherein:
the plurality of requests is a sequence of requests ordered in time;
the event data includes a plurality of timestamps;
each timestamp of the plurality of timestamps respectively corresponds to one request of the plurality of requests;
the document includes a reference to an item available for sale; and
the plurality of requests includes at least one of:
a request to execute a query generated by the first user;
a request to view a search result provided to the first client device by the network-based publication system in response to the query generated by the first user;
a request to initiate a purchase of the item available for sale.

21. A computer-implemented method comprising:
accessing event metadata of a document that is available from a network-based publication system communicatively coupled to a first client device of a first user, the event metadata being representative of a plurality of requests made by the first user to the network-based publication system, the plurality including first and second requests, the second request of the plurality being a request to retrieve the document to the first client device;
receiving a further request to retrieve the document to a second client device communicatively coupled to the network-based publication system, the further request being made by a second user using the second client device;
generating a web page that includes the document and at least some of the event metadata, the generating of the web page being performed by a module implemented using a processor of a machine; and
providing the web page to the second client device in response to the further request.

22. A system comprising:
an access module to access event metadata of a document that is available from a network-based publication system communicatively coupled to a first client device of a first user, the event metadata being representative of a plurality of requests made by the first user to the network-based publication system, the plurality including first and second requests, the second request of the plurality being a request to retrieve the document to the first client device;
a reception module to receive a further request to retrieve the document to a second client device communicatively coupled to the network-based publication system, the further request being made by a second user using the second client device;
a hardware-implemented generator module to generate a web page that includes the document and at least some of the event metadata, the generating of the web page being performed by a module implemented using a processor of a machine; and
a server module to provide the web page to the second client device in response to the further request.

23. A machine-readable storage medium comprising instructions that, when executed by one or more processors of a machine, cause the machine to perform a method comprising:
accessing event metadata of a document that is available from a network-based publication system communicatively coupled to a first client device of a first user, the event metadata being representative of a plurality of requests made by the first user to the network-based publication system, the plurality including first and second requests, the second request of the plurality being a request to retrieve the document to the first client device;
receiving a further request to retrieve the document to a second client device communicatively coupled to the network-based publication system, the further request being made by a second user using the second client device;
generating a web page that includes the document and at least some of the event metadata; and
providing the web page to the second client device in response to the further request.
